(19) United States
(12) Patent Application Publication
(10) Pub. No.: US 2017/0012329 A1
(43) Pub. Date: Jan. 12, 2017

(54) Traction Battery Assembly with Dual Sided Thermal Plate

(71) Applicant: Ford Global Technologies, LLC, Dearborn, MI (US)

(72) Inventors: Eid FARHA, Ann Arbor, MI (US); Michael REIBLING, Sterling Heights, MI (US)

(21) Appl. No.: 14/793,883

(22) Filed: Jul. 8, 2015

(51) Int. Cl. H01M 10/625; H01M 10/65; H01M 2/20; H01M 10/613

(52) U.S. Cl. CPC H01M 10/625; H01M 10/613; H01M 10/65; H01M 2/206; H01M 2220/20

(57) ABSTRACT

A battery assembly includes a thermal plate having a pair of opposing thermal surfaces and a coolant flow field defined therebetween. Each of the thermal surfaces defines at least one threaded hole that extends into the flow field. The battery assembly further includes first and second cell arrays each disposed against a different one of the thermal surfaces and attached to the thermal plate via a fastener received in one of the threaded holes.

### TECHNICAL FIELD

The present disclosure relates to traction battery assemblies for motor vehicles, and particularly fraction batteries having dual sided thermal plates.

### BACKGROUND

Vehicles such as battery-electric vehicles and hybrid-electric vehicles contain a traction battery assembly to act as an energy source for the vehicle. The traction battery may include components and systems to assist in managing vehicle performance and operations. The traction battery may also include high voltage components, and may include an air or liquid thermal-management system to control the temperature of the battery.

### SUMMARY

According to one embodiment, a battery assembly includes a thermal plate having a pair of opposing thermal surfaces and a coolant flow field defined therebetween. Each of the thermal surfaces defines at least one threaded hole that extends into the flow field. The battery assembly further includes first and second cell arrays each disposed against a different one of the thermal surfaces and attached to the thermal plate via a fastener received in one of the threaded holes.

According to another embodiment, a battery assembly includes a thermal plate having opposing thermal surfaces and a coolant flow field disposed therebetween. A plurality of threaded holes are defined in each of the thermal surfaces and extend into the flow field. The assembly further includes cell arrays that are each disposed on one of the thermal surfaces and attached to the thermal plate via fasteners received in a corresponding one of the threaded holes. Each of the thermal surfaces has at least two arrays disposed thereon.

According to yet another embodiment, a battery assembly includes a cast aluminum thermal plate having a pair of opposing thermal surfaces each defined on respective major walls. A coolant flow field is defined between the major walls and interconnecting walls that extend between the major walls. At least one shoulder is disposed on each of the major walls and extends inwardly into the flow field. Each of the shoulders defines a blind threaded hole extending inwardly from the thermal surface. The assembly also includes a first cell array disposed on one of the thermal surfaces and a second cell array disposed on the other of the thermal surfaces. Each of the arrays is attached to the thermal plate via a fastener received in one of the threaded holes.

### BRIEF DESCRIPTION OF THE DRAWINGS

FIG. 1 is a schematic diagram of an example hybrid vehicle.

FIG. 2 is a perspective view of a traction battery assembly.

FIG. 3 is a side view of the battery assembly.

FIG. 4 is a front view, in cross-section, of the battery assembly along cutline 4-4.

FIG. 5 is a side view of a thermal plate of a battery assembly according to an alternative embodiment.

FIG. 6 is a front view, in cross-section, of the thermal plate along cutline 6-6

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

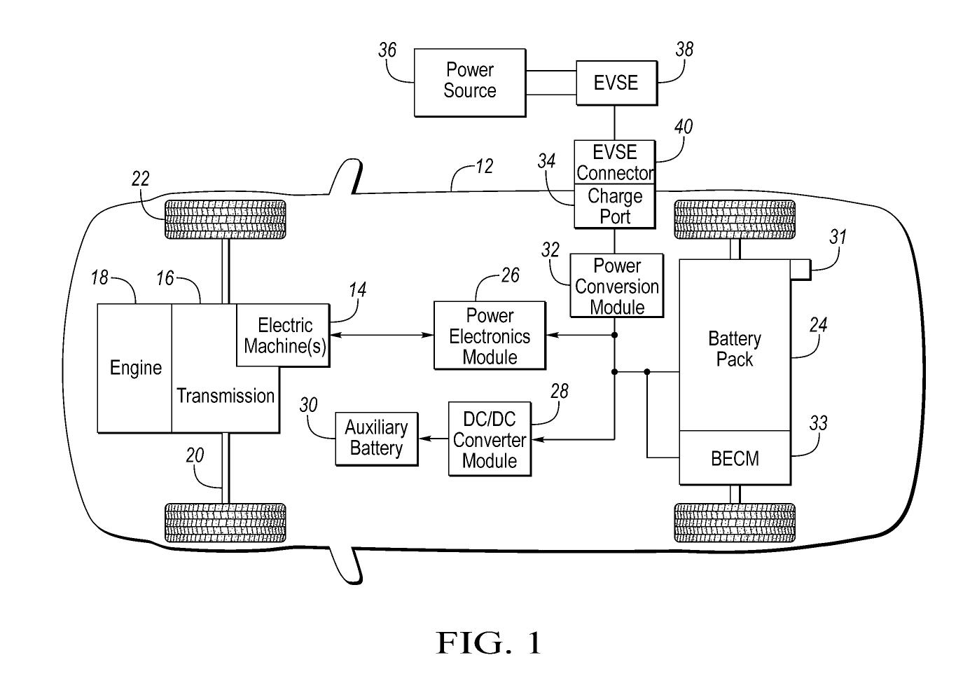

FIG. 1 depicts a schematic of a typical plug-in hybrid-electric vehicle (PHEV). Certain embodiments, however, may also be implemented within the context of non-plug-in hybrids and fully-electric vehicles. The vehicle 12 includes one or more electric machines 14 mechanically connected to a hybrid transmission 16. The electric machines 14 may be capable of operating as a motor or a generator. In addition, the hybrid transmission 16 may be mechanically connected to an engine 18. The hybrid transmission 16 may also be mechanically connected to a drive shaft 20 that is mechanically connected to the wheels 22. The electric machines 14 can provide propulsion and deceleration capability when the engine 18 is turned on or off The electric machines 14 also act as generators and can provide fuel economy benefits by recovering energy through regenerative braking The electric machines 14 reduce pollutant emissions and increase fuel economy by reducing the work load of the engine 18.

A traction battery or battery pack 24 stores energy that can be used by the electric machines 14. The traction battery 24 typically provides a high voltage direct current (DC) output from one or more battery cell arrays, sometimes referred to as battery cell stacks, within the traction battery 24. The battery cell arrays may include one or more battery cells.

The battery cells, such as a prismatic, pouch, cylindrical, or any other type of cell, convert stored chemical energy to electrical energy. The cells may include a housing, a positive electrode (cathode) and a negative electrode (anode). An electrolyte may allow ions to move between the anode and cathode during discharge, and then return during recharge. Terminals may allow current to flow out of the cell for use by the vehicle.

Different battery pack configurations may be available to address individual vehicle variables including packaging constraints and power requirements. The battery cells may be thermally regulated with a thermal management system. Examples of thermal management systems include air cooling systems, liquid cooling systems and a combination of air and liquid systems.

The traction battery 24 may be electrically connected to one or more power electronics modules 26 through one or more contactors (not shown). The one or more contactors isolate the traction battery 24 from other components when opened and connect the traction battery 24 to other components when closed. The power electronics module 26 may be electrically connected to the electric machines 14 and may provide the ability to bi-directionally transfer electrical energy between the traction battery 24 and the electric machines 14. For example, a typical traction battery 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. The description herein is equally applicable to a fully-electric vehicle. In a fully-electric vehicle, the hybrid transmission 16 may be a gear box connected to an electric machine 14 and the engine 18 is not present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle components. Other high-voltage loads, such as compressors and electric heaters, may be connected directly to the high-voltage supply without the use of a DC/DC converter module 28. In a typical vehicle, the low-voltage systems are electrically connected to an auxiliary battery 30 (e.g., a 12 volt battery).

A battery energy control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by a charging station connected to an external power source 36. The external power source 36 may be electrically connected to electric vehicle supply equipment (EVSE) 38. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus (e.g., Controller Area Network (CAN)) or via dedicated electrical conduits.

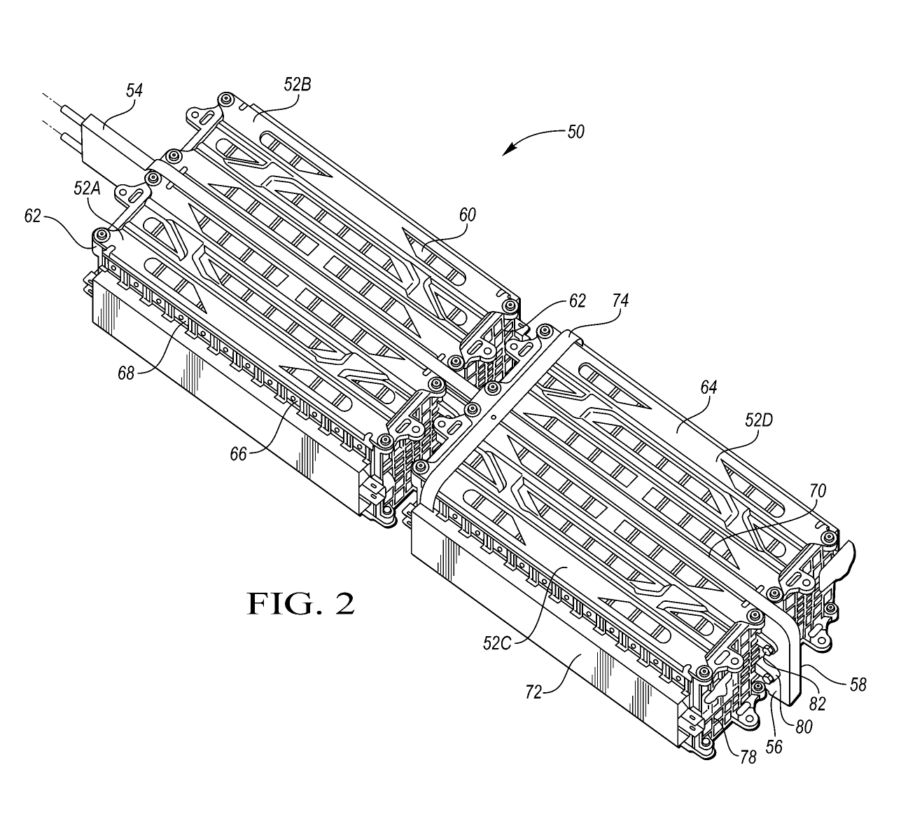

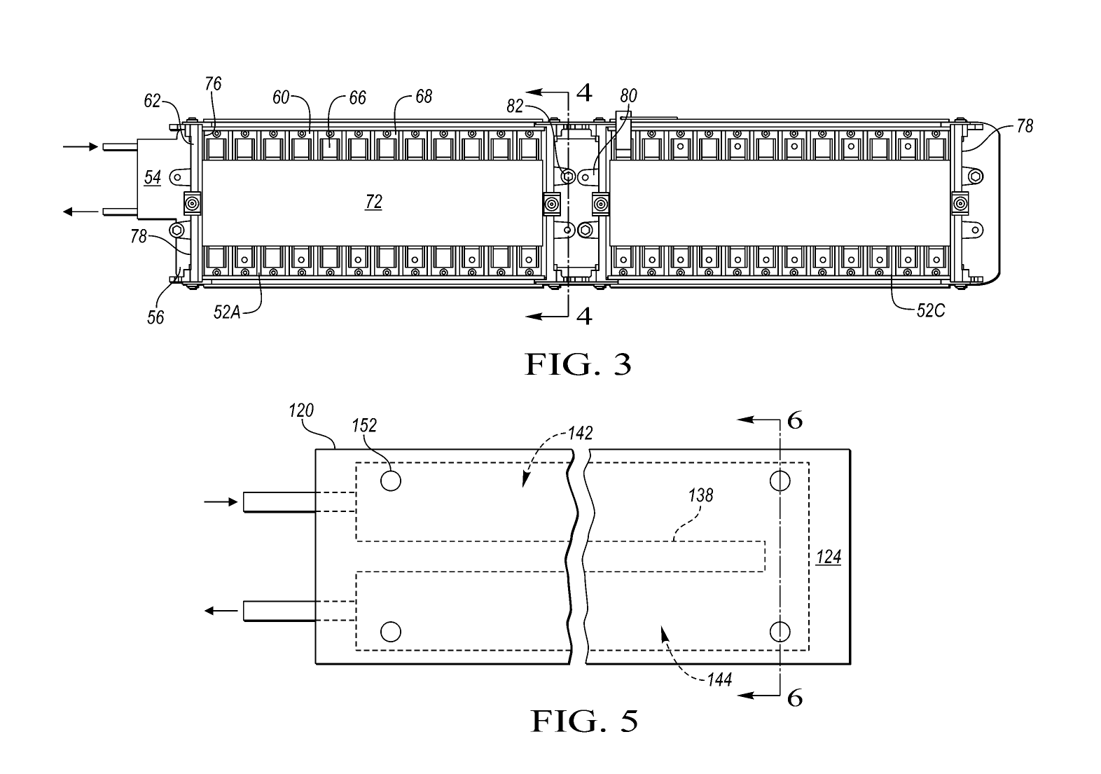

FIGS. 2 through 6 and the related discussion describe examples of the traction battery assembly 24. Referring to FIGS. 2 and 3, a traction battery assembly 50 includes at least two battery arrays 52A, 52B attached on opposite sides of a thermal plate 54. In the illustrated example embodiment, the traction battery 50 includes four arrays (52A, 52B, 52C, and 52D). The four arrays 52 are arranged with two arrays on each side of the thermal plate 54 and with the arrays on a same side being axially aligned in a side-by-side configuration. The thermal plate 54 includes a first thermal surface 56 that engages with the battery array 52A, and a second thermal surface 58 that engages with the battery array 52B. The thermal plate 54 also includes a flow field disposed between the thermal surfaces. The thermal plate 54 is configured to circulate coolant through the flow field to add or remove heat to/from the battery arrays 52.

Each of the arrays 52 includes a plurality of stacked cells 60 that are sandwiched between a pair of endplates 62. Bracketry 64 extends between the pair of endplates 62 to secure the cells 60 in place. The endplates 62 may provide compression to the cells 60. Each of the cells 60 includes a terminal side 66 that has at least one terminal 68, and an engaging side 70 configured to engage with the thermal plate 54. A thermal interface material may be disposed between the engaging side and the thermal surface. The engaging side 70 may be on a side of the cell 60 opposite the terminal side 66. The terminals 68 of select cells may be mechanically coupled together to electrically connect the cells of the array in series or parallel. For example, a busing assembly 72 may be disposed against the terminal side 66 of each of the cells 60 and extend along a length of the array 52. The busing assembly 72 may include a plurality of busbars (not shown) mechanically and electrically connected to select cells. A crossover busbar 74 may electrically connect the arrays. For example, the busbar 74 electrically connects array 52C with array 52D.

Each of the endplates 62 includes an inner surface 76 that faces the cells 60 and an outer surface 78 facing away from the array. A mounting tab 80 may be connected to the outer surface 78. The mounting tab 80 may be integral with the end plate. The mounting tab 80 may extend substantially perpendicular to the outer surface 78 and be located along an edge portion of the endplate near the engaging side 70 of the cells. The mounting tab 80 is used to attach each of the arrays to the thermal plate 54. The arrays 52 may be attached to the thermal plate 54 via a fastener 82 that is received through the mounting tabs 80 and disposed within a blind threaded hole defined in the thermal plate 54. (This will be described in detail below).

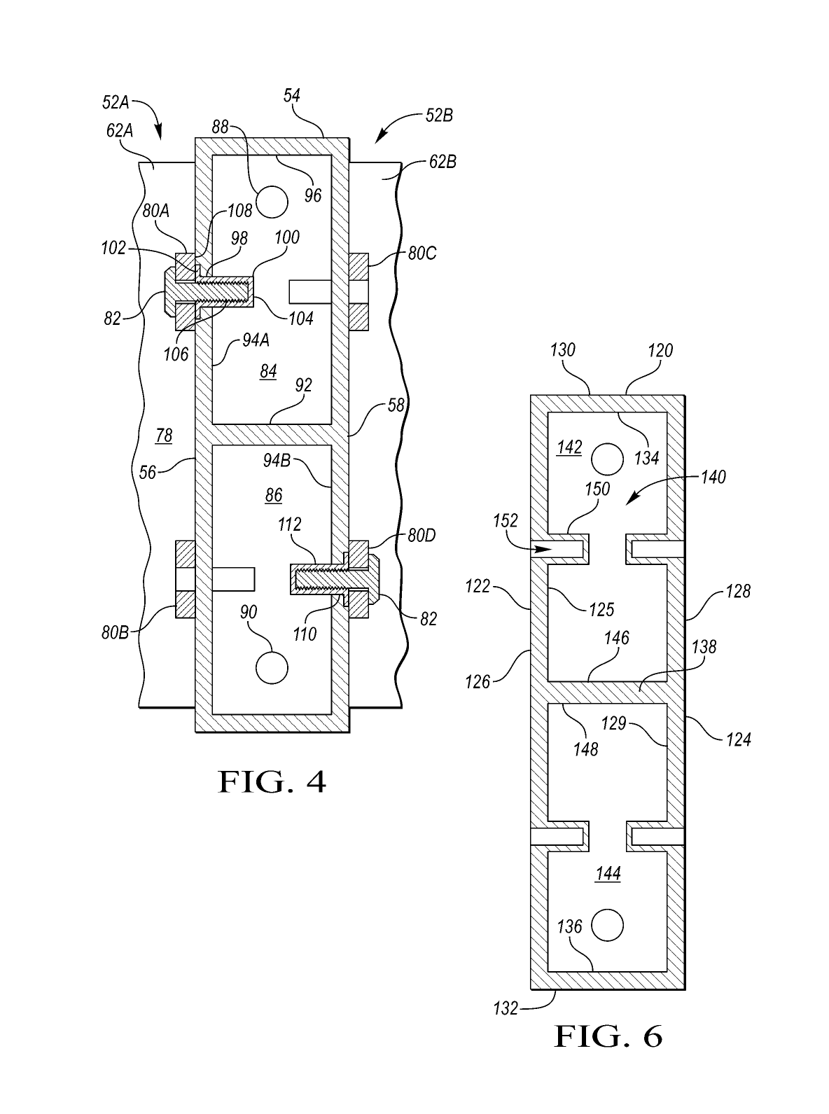

Referring to FIG. 4, a cross-sectional view along cutline 4-4 is illustrated. The coolant flow field may be partitioned into an upper chamber 84 and a lower chamber 86 by a separator wall 92. The upper and lower chambers are interconnected—such as, at one end of the thermal plate 54. The upper chamber 84 may be disposed on the inlet side of the coolant flow field and includes an inlet port 88. The lower chamber 86 may include an outlet port 90. In some embodiments the upper chamber 84 may include the outlet port and the lower chamber 86 may include the inlet port. Each of the chambers may be defined by a plurality of internal walls. For example, each of the upper and lower chambers 84 may be defined by a pair of major internal walls 94A and 94B. Each of the major internal walls may be substantially parallel to the thermal surfaces 56, 58. A plurality of internal interconnecting walls 96 may extend between the major walls 94.

The thermal plate 54 includes a plurality of boreholes extending between the thermal surfaces and the internal walls. For example, a first borehole 98 extends between the first thermal surface 56 and the major internal wall 94. The sleeve 100 is installed into the borehole 98. The sleeve includes a head portion 102 and a shank 104. The head portion 102 is disposed on, or slightly recessed into, the thermal surface 56. The sleeve 100 defines a tapped hole 106 for receiving a fastener.

The first battery array 52A is disposed against the first thermal surface 56. The upper mounting tab 80A, which is part of endplate 62A, includes an engaging surface 108 that is disposed against the first surface 56. The endplate 62A is designed and positioned such that the upper mounting tab 80A is disposed over the sleeve 100 when installed. The upper mounting tab 80A defines a hole that aligns with the tapped hole 106. A fastener 82 is received through the mounting tab 80 and threads into the tapped hole 106 to secure the endplate 62A to the thermal plate 54. The endplate 62A also includes a lower mounting tab 80B. In some designs, a fastener 82 is only installed into one of the mounting tabs on each endplate.

The second battery array 52B is disposed against the second thermal surface 58. The second battery array 52B includes an endplate 62B that also has upper and lower mounting tabs 80C and 80D. The thermal plate 54 defines a borehole 110 that receives a sleeve 112. A fastener 82 is threaded through mounting tab 80D to secure the endplate 62B to the thermal plate 54. In the illustrated embodiment, the sleeves on each side of the thermal plate 54 alternate to reduce drag on the coolant within the flow fields. For example, the first endplate 62A is attached at the upper tab and the second endplate 62B is attached at the lower tab.

The thermal plate 54 may be made out of any thermally conducting material—such as thermally conductive plastic or metal. For example the thermal plate 54 may be made out of stamped, extruded, or cast aluminum.

FIGS. 5 and 6 illustrate a thermal plate 120 that is formed of cast metal, such as cast aluminum or cast iron. The casting 120 includes a first wall 122 on one side of the casting and a second wall 124 on the other side of casting. The first wall 122 defines a first thermal surface 124 and an inner surface 125. The second wall 126 defines second thermal surface 128 and an inner surface 129. The casting 120 also includes a top 130 that defines an inner surface 134, and a bottom 132 that defines an inner surface 136.

The casting 120 defines a coolant flow field 140. The flow fields 140 may have a plurality of different shapes depending upon the embodiment. In the illustrated embodiment, the casting 120 has a U-shaped flow field. The flow field 140 has an upper chamber 142 and a lower chamber 144 that are partitioned by a separator wall 138 extending between inner surface 125 and inner surface 129. The separator wall 138 defines a top surface 146 and a bottom surface 148. The upper chamber 142 is defined, at least in part, by surfaces 125, 134, 129, and 146. The lower chamber 144 is defined, at least in part, by surfaces 125, 129, 136, and 148.

The casting 120 includes shoulders 150 located at the fastener receiving areas. The shoulders 150 provide a structure for the blind threaded holes 152. The shoulders 150 are disposed on one of the inner surfaces 125 or 129. Each of the shoulders 150 are integral with one of the first or second walls 122 or 126 and extends inwardly into the flow field 140. The battery arrays are attached to the thermal plate 120 via fasteners that thread into the holes 152, as described above with the other embodiments.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A battery assembly comprising:
a thermal plate including a pair of opposing thermal surfaces and a coolant flow field defined therebetween, wherein each of the thermal surfaces defines at least one threaded hole that extends into the flow field; and
first and second cell arrays each disposed against a different one of the thermal surfaces and attached to the thermal plate via a fastener received in one of the threaded holes.

2. The battery assembly of claim 1 wherein each of the first and second cell arrays further includes a pair of endplates each having at least one mounting tab cooperating with a corresponding one of the threaded holes and fastener to attach the array to the thermal plate.

3. The battery assembly of claim 1 wherein each of the cell arrays further includes a plurality of cells stacked together and a pair of endplates sandwiching the cells.

4. The battery assembly of claim 3 wherein each of the endplates further includes an inner surface engaging one of the cells and an outer surface, wherein the outer surface includes a mounting tab extending outwardly therefrom and cooperating with a corresponding one of the threaded holes to attach the array to the thermal plate.

5. The battery assembly of claim 4 wherein the mounting tab further includes an engaging surface that is oriented substantially perpendicular to the outer surface of the endplate.

6. The battery assembly of claim 5 wherein the engaging surface defines a hole and a corresponding fastener is disposed in the hole.

7. The battery assembly of claim 1 wherein the thermal plate further includes internal walls that define the coolant flow field and wherein the thermal plate is configured to circulate coolant through the coolant flow field to dissipate heat from the arrays.

8. The battery assembly of claim 1 wherein each of the thermal surfaces defines a bore hole and a sleeve disposed within each bore hole and wherein each of the sleeves defines one of the threaded holes.

9. A battery assembly comprising:
a thermal plate including opposing thermal surfaces and a coolant flow field disposed therebetween;
a plurality of threaded holes defined in each of the thermal surfaces and extending into the flow field; and
cell arrays each disposed on one of the thermal surfaces and attached to the thermal plate via fasteners received in a corresponding one of the threaded holes, wherein each of the thermal surfaces has at least two arrays disposed thereon.

10. The battery assembly of claim 9 wherein each of the arrays further includes a pair of endplates each having mounting tabs cooperating with corresponding threaded holes and fasteners to attach the array to the thermal plate.

11. The battery assembly of claim 9 wherein each of the cell arrays further includes a plurality of cells stacked together and a pair of endplates sandwiching the cells.

12. The battery assembly of claim 11 wherein each of the endplates further includes an inner surface engaging one of the cells and an outer surface, wherein the outer surface includes a mounting tab extending outwardly therefrom and cooperating with one of the threaded holes and one of the fasteners to attach the array to the thermal plate.

13. The battery assembly of claim 9 wherein cell arrays on a same thermal plate are axially arranged in a side by side position.

14. The battery assembly of claim 9 further comprising a busbar mechanically and electrically connecting a cell array on one of the thermal surfaces with a cell array on the other of the thermal surfaces.

15. A battery assembly comprising:
a cast aluminum thermal plate including a pair of opposing thermal surfaces each defined on respective major walls, a coolant flow field defined between the major walls and interconnecting walls that extend between the major walls, and at least one shoulder disposed on each of the major walls and extending inwardly into the flow field, wherein each of the shoulders defines a blind threaded hole extending inwardly from the thermal surface;
a first cell array disposed on one of the thermal surfaces; and
a second cell array disposed on the other of the thermal surfaces, wherein each of the arrays is attached to the thermal plate via a fastener received in one of the threaded holes.

16. The battery assembly of claim 15 further comprising third and fourth cell arrays each disposed on one of the thermal surfaces and attached to the thermal plate via a fastener received in one of the threaded holes, wherein the first and third arrays are on a same thermal surface, and the second and fourth arrays are on a same thermal surface.

17. The battery assembly of claim 16 wherein the first and third cell arrays are axially aligned and disposed side by side.

18. The battery assembly of claim 15 wherein each of the cell arrays further includes a plurality of cells stacked together and a pair of endplates sandwiching the cells.

19. The battery assembly of claim 18 wherein each of the endplates further includes an inner surface engaging one of the cells and an outer surface, wherein the outer surface includes a mounting tab extending outwardly therefrom and cooperating with a corresponding blind threaded hole and fastener to attach the array to the thermal plate.
